(19) United States
(12) Patent Application Publication
(10) Pub. No.: US 2012/0140265 A1
(43) Pub. Date: Jun. 7, 2012

(54) METHOD AND SYSTEM FOR SCHEDULED DELIVERY OF CONTENT

(76) Inventors: Dana E. Laursen, Corvallis, OR (US); Thomas M. Carrico, Corvallis, OR (US)

(21) Appl. No.: 12/960,420

(22) Filed: Dec. 3, 2010

(51) Int. Cl. G06F 3/12

(52) U.S. Cl. 358/1.15

(57) ABSTRACT

In one embodiment, source content is obtained from a computing system. A request is received, the request for scheduled automatic delivery, without user intervention, of subscribed-for content to a web-enabled printer. The subscribed-for content comprises at least a portion of the source content. A protocol for printing of the subscribed-for content is established based at least in part on information from the request and data stored in a memory. The subscribed-for content is caused to be formatted in accordance with the protocol. The subscribed-for content is caused to be obtained by the printer.

### BACKGROUND

Many users of computing devices choose to receive news and other published content via a web connection, rather than purchasing hardcopy editions of the content at a retailer or receiving hard copy editions via postal delivery. Some users prefer to view the content via a monitor other user interface while connected to the Internet. Some users prefer to access the content via the Internet, and then print the content at a local printing device to create a hard copy version for later viewing. Other users prefer to arrange to have online content sent to the user's printing device at scheduled times, such that the user can pick up a hard copy version at the printer at a convenient time.

### BRIEF DESCRIPTION OF THE DRAWINGS

The accompanying drawings illustrate various embodiments and are a part of the specification. The illustrated embodiments are merely examples and do not limit the scope of the claims. Throughout the drawings, identical reference numbers designate similar, but not necessarily identical elements.

FIG. 1 depicts an example environment in which various embodiments may be implemented.

FIG. 2 depicts the physical and logical components of a content manager according to an embodiment.

FIGS. 3-6 depict example content managing services according to embodiments.

FIGS. 7 and 8 are example flow diagrams depicting embodiments of a method for scheduled delivery of content.

FIG. 9 is a screen shot depicting an example user interface from which a request for scheduled automatic delivery may be initiated, according to an embodiment.

The same part numbers designate the same or similar parts throughout the figures.

### DETAILED DESCRIPTION OF EMBODIMENTS

Subscribing for online delivery of published content can be a difficult process. In the past, subscribing for online delivery of content to a printing device might entail multiple steps including accessing a web site of the content publisher, downloading software to a client personal computer, providing information to the publisher regarding formatting requirements or regarding printer constraints, and/or specifying a delivery schedule. Embodiments described below were developed in an effort to provide a method and system for scheduled delivery of published content that is more convenient because of reduced complexity from the perspective of a user. Because the user performs fewer steps and may interact with a simple interface, the user is more likely to utilize a scheduled delivery option and user satisfaction is increased.

The embodiments shown in the accompanying drawings and described below are non-limiting examples. Other embodiments are possible and nothing in the accompanying drawings or in this Detailed Description of Embodiments should be construed to limit the scope of the disclosure, which is defined in the Claims.

The following description is broken into sections. The first, labeled “Environment”, describes an example environment in which embodiments may be implemented. The second section, labeled “Components”, describes various physical and logical components utilized to implement various embodiments. The third section, labeled as “Operation”, describes example embodiments of a method for scheduled delivery of content. The fourth section, labeled “Example”, describes an example user interface, according to an embodiment of the disclosure.

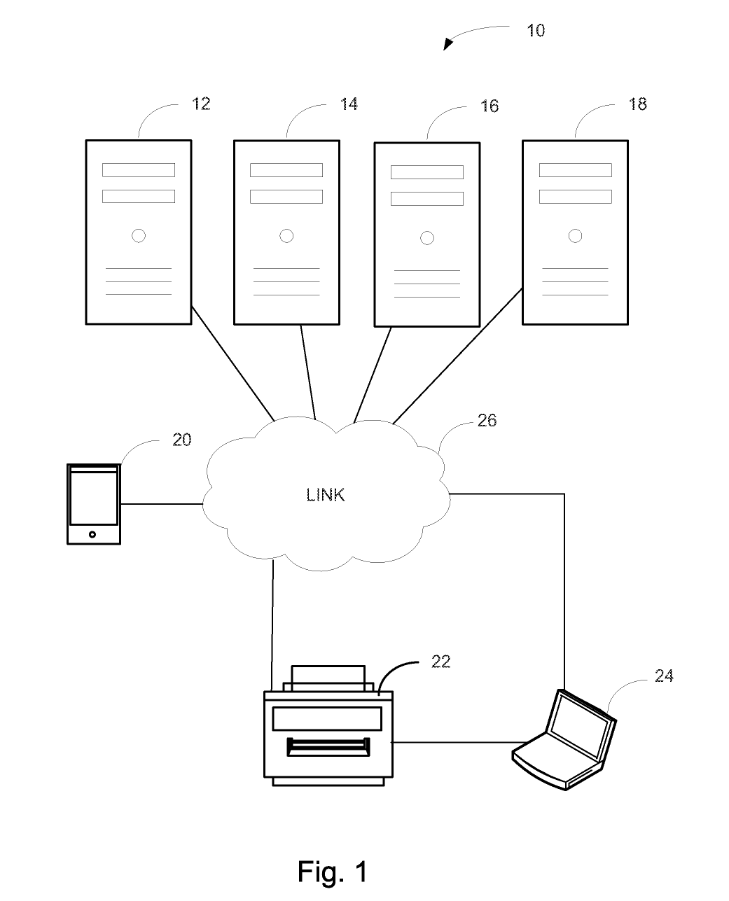

ENVIRONMENT: FIG. 1 depicts an example environment 10 in which various embodiments may be implemented. Environment 10 is shown to include servers 12, 14, 16, and 18, computing devices 20 and 24, and a web-enabled printer 22. Each of servers 12, 14, 16 and 18 represent generally one or more computing devices capable of receiving and responding to network requests from each other and/or other computing devices via a link 26. Network requests may be sent and received utilizing a networking protocol, including but not limited to Transmission Control Protocol/Internet Protocol (“TCP/IP”), HyperText Transfer Protocol (“HTTP”), Simple Mail Transfer Protocol (“SMTP”), Extensible Messaging and Presence Protocol (“XMPP”) and/or Session Initiation Protocol (“SIP”). In an example environment, servers 12, 14, and 16 are each part of different computing systems, and servers 16 and 18 are servers in a same computing system.

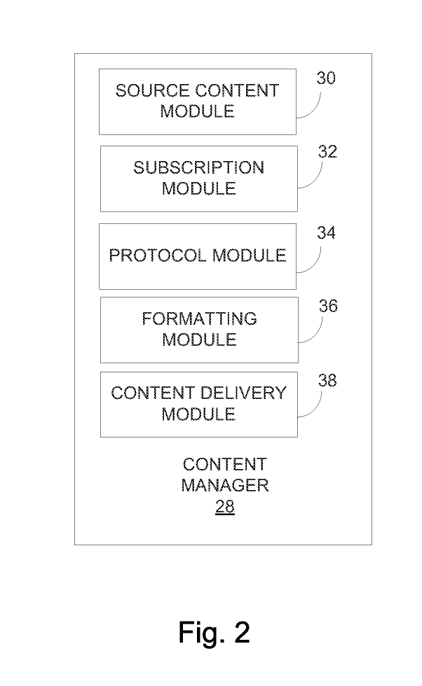

As discussed with reference to FIGS. 2-6 below, server 16 may be a computing device configured to receive source content from another computing device such as server 12 and/or server 14. Server 16 may be additionally configured to receive a request for scheduled automatic delivery of subscribed-for content to a web-enabled printer, such as printer 22. As used in this specification and the appended claims, “printer” and “printing device” are used synonymously. Server 16 may receive the request from the web-enabled printer 22, or from a computing device such as computing device 20. Computing device 20 represents generally any computing device capable of communicating with server 16 via a network. Computing device 20 may be a mobile computing device. Example mobile computing devices include smart phones, personal digital assistants, net-books, digital media players, and the like.

Server 16 may be additionally configured to establish a protocol for printing of the subscribed-for content based at least in part on information discerned from the request and stored data, to cause formatting of the subscribed-for content, and to cause the content to be obtained by web-enabled printer 22 for printing. Server 18 may be a computing device configured to receive subscribed-for content from server 16, and to format the subscribed-for content in accordance with the protocol.

Printer 22 represents generally an assembly of components configured to produce printed images of media to produce printed output. Printer 22, for example, may be used for printing photographs, forms, advertisements, coupons and the like. In this example, printer 22 is a web-enabled printer. As used in this specification and the appended claims, a “web-enabled printer” means a printer that can be connected to the Internet or an intranet, so as to be capable of obtaining content, sending and receiving messages, and/or running applications via the Internet or an intranet. In an embodiment a web-enabled printer 22 may operate in a standalone mode without being connected to a host computing device. In such an example printer 22 may be configured to receive print jobs via the Internet, email or an external memory device. In another embodiment printer 22 is connected to a host computing device 24 via a cable or wireless or other means in a manner such that printer 22 may receive instructions and print jobs from host 24. In another embodiment, printer 22 may connect directly to one or more hosts via the Internet or an intranet. In an embodiment, a web enabled printer 22 may be a printer that is not itself connected to the Internet or an intranet, but rather is connected to the Internet or the intranet by virtue of being connected, e.g. via a cable or wireless connection, to a host computing device that is connected to the Internet or intranet.

Computing devices 12, 14, 16, 18, 20, 22, and 24 may be interconnected via link 26. Link 26 represents generally one or more of a cable, wireless, fiber optic, or remote connections via a telecommunication link, an infrared link, a radio frequency link, or any other connectors or systems that provide electronic communication. Link 26 may include, at least in part, the Internet, an intranet, or a combination of both. Link 26 may also include intermediate proxies, routers, switches, load balancers, and the like. The paths followed by link 26 between computing devices 12, 14, 16, 18, 20, 22, and 24 as depicted in FIG. 1 represent the logical communication paths between these devices, not necessarily the physical paths between the devices.

COMPONENTS: FIG. 2 is an example block diagram illustrating the physical and logical components of a content manager 28. Content manager 28 represents generally any combination of hardware and programming configured for use for scheduled delivery of content. Content manager 28 may be implemented in a number of environments, such as environment 10 of FIG. 1. In the example of FIG. 2, content manager 28 is shown to include a source content module 30, a subscription module 32, a protocol module 34, a formatting module 36, and a content delivery module 38.

Source content module 30 represents generally any combination of hardware and programming configured to receive source content from a computing system. As used in this specification and the appended claims, “content” refers to information that can be received by and stored at a computer system for possible later presentation to a user. Example visual content includes text, graphics and other images capable of being visually displayed and/or printed at a printing device. Content may also include instructions designed to be processed by a computing device. Example content formats may include PDF and other page description formats, HTML, RSS feeds and other XML formats, JPEG, TIFF and other image formats, and document formats such as Microsoft® Word, Microsoft Excel®, and Adobe InDesign®). As used in this specification and the appended claims, “source content” refers to a library, repository, or store of content that can be electronically stored in a memory. In an embodiment, source content is obtained from a computing device that is part of a computing system of a content publisher, e.g. a web site. In an embodiment, first source content is obtained from a first computing system, and second source content is obtained from a separate second computing system. For example, first source content may be obtained from a first computing device that is a part of a computing system of a news publisher, and second source content may be obtained from a second computing device that is part of a computing system of an entertainment publisher. In certain embodiments, source content may also include other information, such as audio information, that is capable of being transformed to a printable format and then printed at a printing device. For example, in a particular embodiment, audio source content may be obtained by source content module 30 and then converted to a visual format, e.g. text, at some point prior to printing.

Subscription module 32 represents generally any combination of hardware and programming configured to receive a request for scheduled automatic delivery, without user intervention, of subscribed-for content to a web-enabled printer. As used in this specification and the appended claims, “subscribed-for content” refers to content that is requested for scheduled automatic delivery to a web-enabled printer. The subscribed-for content comprises at least a portion of the source content that is obtained via the source content module 30. In an embodiment, the request is a request for multiple scheduled automatic deliveries, and updated source content is periodically obtained from a computing system via the source content module 30. In an embodiment, the received request is a request that is initiated via a user's interaction with an interface at a printer. In an embodiment, the received request is a request that is initiated via a user's interaction with a single icon on a user interlace at a printer. In another embodiment, the received request is a request that is initiated via a user's interaction with a user interface at a web-enabled computing device other than a printer. In an embodiment, the received request is a request that is initiated via a user's interaction with a single icon on the user interface at the device.

Protocol module 34 represents generally any combination of hardware and programming configured to establish a protocol for printing of the subscribed-for content at a web-enabled printer. In an embodiment, the protocol includes scheduling the delivery to occur within a range of times. In an embodiment, the protocol includes requirements specific to the capabilities of the web-enabled printer. The protocol is established based at least in part on information from the request for scheduled automatic delivery and data stored in a memory. In an embodiment, the information that is utilized in establishing the protocol includes information regarding the model or type of printer, and the data that is stored in memory includes the capabilities and features of the model or type of printer. In an embodiment, the information that is utilized in establishing the protocol includes information regarding the physical location of the web-enabled printer that will print the subscribed-for content, and the data that is stored in memory includes time zone information relevant to the physical location of the printer. In another embodiment, the information may include information regarding a user, and the data that is stored in memory may include the user's printing preferences.

Formatting module 36 represents generally any combination of hardware and programming configured to causing formatting of the subscribed-for content in accordance with the protocol established by the protocol module. In an embodiment, the formatting of the subscribed-for content occurs at a second computing device that is distinct from a first computing device, the first computing device being the device that receives the request for delivery of subscribed-for content to the printer and that receives the source content. In another embodiment, the formatting occurs at a computing device that is connected to the printer. In another embodiment, the formatting occurs at the printer.

Content delivery module 38 represents generally any combination of hardware and programming configured to cause the subscribed-for content to be obtained by the web-enabled printer. In an embodiment where the formatting occurs at a second computing device distinct from a first computing device that receives the request and source content, the subscribed-for content is obtained by the printer after the formatting. In an embodiment where the formatting occurs at a computing device that is connected to the printer, the subscribed-for content is obtained by the printer after the formatting. In an embodiment in which the formatting occurs at the printer, the subscribed-for content is obtained by the printer prior to the formatting step.

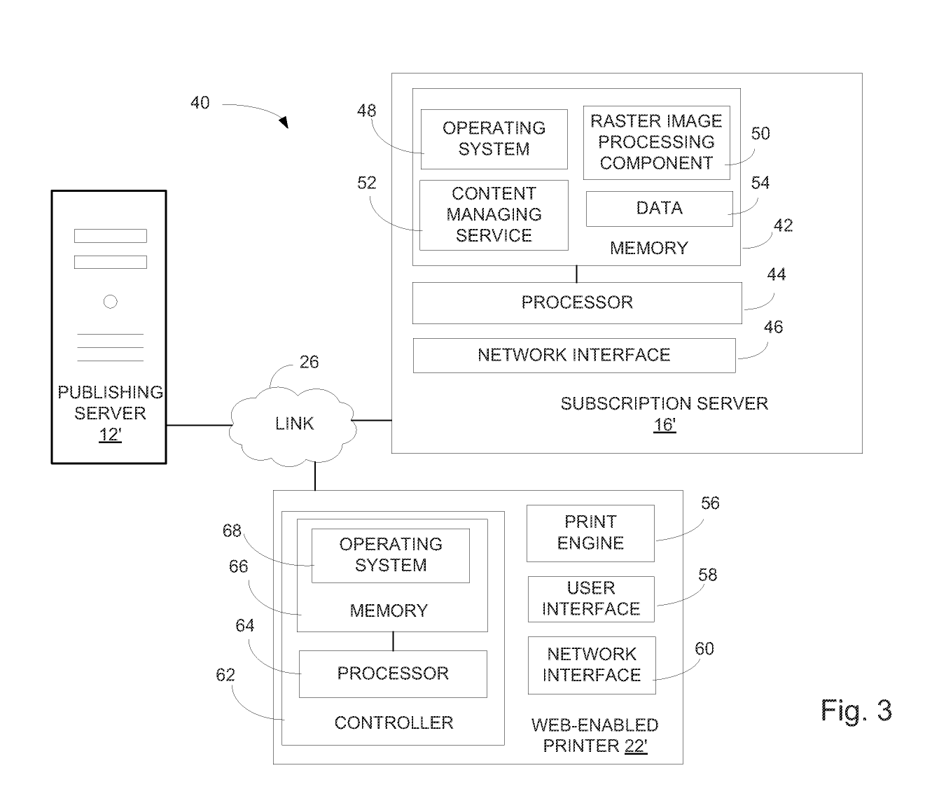

Content manager 28 may be implemented in a number of environments, such as environment 40 of FIG. 3. Environment 40 includes publishing server 12′, subscription server 16′ and web-enabled printer 22′ interconnected via link 26.

Publishing server 12′ represents generally any computing device capable of providing source content to and communicating with subscription server 16′, and receiving information relating to the source content from subscription server 16′. In an embodiment, a publishing server 12′ providing source content may include sending or pushing the source content to a subscription server 16′. In an embodiment, a publishing server 12′ providing source content may include sending the source content to a holding destination where the source content is subsequently retrieved or pulled by subscription server 16′. For example, publishing server 12′ may send the source content to a FTP site or RSS feed, where the source content is subsequently retrieved by subscription server 16′. In an embodiment, publishing server 12′ provides updated source content to subscription server 16′ at regular, e.g. daily, weekly, or monthly, intervals.

Subscription server 16′ represents generally any computing device capable of obtaining content from, and communicating with, publishing server 12′. Subscription server 16′ is additionally capable of receiving requests for subscribed-for content from, causing subscribed-for content to be obtained by, and communicating with, a web-enabled printer 22′. Subscription server 16′ is shown to include a memory 42, a processor 44, and a network interface 46. In a given implementation, processor 46 may represent multiple processors, and the memory 42 may represent multiple memories. In an embodiment, the subscription server 16′ may include a number of software components that are stored in a computer-readable medium, such as memory 42, and are executable by processor 44. In this respect, the term “executable” includes a program file that is in a form that can be directly (e.g. machine code) or indirectly (e.g. source code that is to be compiled) performed by the processor 44. An executable program may be stored in any portion or component of memory 42. In an embodiment, subscription server 16′ is a part of a first computing system that is separate from a second computing system that includes publishing server 12′.

Memory 42 is shown to include an operating system 48, a raster image processing component 50, a content managing service 52, and data 54. Operating system 48 represents generally any software platform on top of which other programs or applications such as the raster image processing component 50 and the content managing service 52 run. Examples include Linux® and Microsoft Windows®. Raster image processing component 50 represents generally any combination of hardware and software capable of converting digital information about fonts and graphics that describes the intended appearance of the content, and translating that information into an image composed of individual dots that a printer can output. In embodiments, raster image processing component 50 may be additionally configured to compose page layouts and scaling operations.

Content managing service 52 represents generally any programming, that, when executed, implements the functionality of the content manager 28 of FIG. 2. In particular, content managing service 52, when executed by processor 44, is responsible for obtaining source content from a computing system. In an embodiment, obtaining source content from a publishing server may include causing the source content to be sent directly or indirectly by a publishing server 12′ to subscription server 16′. In an embodiment, obtaining source content from a publishing server may include causing the source content to be retrieved from a holding destination, e.g. an FTP site or RSS feed where the source content has been sent to by publishing server 12′ and made available for direct or indirect retrieval by the subscription server 16′. In an embodiment, obtaining source content from a publishing server may include obtaining the content via a request, e.g. API request via HTTP, from subscription server 16′ to publishing server 12′. In this example, the content may be obtained from publishing server 12′ and stored in memory 42. Content managing service 52 is additionally responsible for receiving a request for scheduled automatic delivery, without user intervention, of subscribed-for content to a web-enabled printer such as printer 22′. The subscribed-for content comprises at least a portion of the source content that is obtained from publishing server 12′. In this example, the received request is a request that is initiated via a user's interaction with a user interface 58 at the web-enabled printer 22′. Content managing service 52 is additionally responsible for establishing a protocol for printing of the subscribed-for content at web-enabled printer 22′. In this example, the protocol is established at least in part on information from the request for scheduled automatic delivery and data 54 stored in a memory 42 within the subscription server 16′. Content managing service 52 is additionally responsible for causing formatting of the subscribed-for content, in accordance with the protocol. In this example, the formatting of the subscribed-for content occurs utilizing a raster image processing component 50 at subscription server 16′. Content managing service 52 is additionally responsible for causing the subscribed-for content to be obtained by the web-enabled printer. In an embodiment, causing content to be obtained by a printer may include causing the subscribed-for content to be sent directly or indirectly from subscription server 16′ to the printer. In an embodiment, causing content to be obtained by a printer may include causing the subscribed-for content to be sent by subscription server 16′ to a holding destination, e.g. an FTP site or RSS feed, where the content is made available for direct or indirect retrieval by printer 22′. Indirect retrieval may include retrieval by a host computing device that is web-enabled and connected to the printer, which host device in turn sends the content to the printer 22′ or allows the printer 22′ to retrieve the content from the host device. In an embodiment, causing subscribed-for content to be obtained by a printer may include obtaining the content via a request, e.g. API request via HTTP, sent to subscription server 16′ by printer 22′. In the example of FIG. 3, as the formatting of the subscribed-for content occurred at subscription server 16′, the content is obtained by the printer 22′ after the formatting.

Data 54 represents generally a collection of information stored in memory 42, the information utilized by content managing service 52 to establish a protocol for printing of the subscribed-for content. In an example, data 54 may include information as to the model or type of web-enabled printer 22′. In another example, data 54 may include time zone information relevant to the physical location of web-enabled printer 22′.

Network Interface 46 represents generally any combination of hardware and programming configured for electronically connecting subscription server 16′ to link 26. In an embodiment, the network interface may comprise a network interface card, a network adapter, a network interface controller, and or a LAN adapter.

Web-enabled printer 22′ represents generally a computing device capable of obtaining subscribed-for content from subscription server 16′, producing printed output from the subscribed-for content, and communicating information relating to the obtained subscribed-for content and/or the printed output back to the subscription server 16′. Web-enabled printer 22′ is shown to include a print engine 56, a user interface 58, a network interface 60, and a controller 62. Print engine 56 represents generally any combination of hardware and programming capable of producing printed output from the subscribed-for content obtained from the subscription server 16′. In particular, print engine 56 utilizes imaging material such as ink or toner to form a desired image on a print medium.

User interface 58 represents generally any combination of hardware and programming that enables a user to enter commands at printer 22′. User interface 58 may be implemented through one or more physical buttons or a touchscreen interface. In an example, user interface 58 is a touchscreen device and includes a combination of hardware and programming capable of presenting a visual display of content for viewing by a user and of receiving a request or other instructions from a user via the user's interaction, e.g. via a touch, with the touchscreen. In an embodiment, the user interface is a touch screen interface configured to display logos, which logos when selected initiate a request for subscribed-for content. In an embodiment, the request for subscribed-for content is initiated by a user's interacting with a single icon displayed by the touchscreen user interface. In an embodiment, the request is initiated by a user's single interaction, e.g. a single touch, with a single icon displayed by a touchscreen user interface.

Network interface 60 represents generally any combination of hardware and programming configured for electronically connecting web-enabled printer 22′ to link 26. As used in this example, controller 62 represents generally any combination of elements capable of acting as an embedded computing device to coordinate the operation of print engine 56, user interface 58 and network interface 60. In a given implementation, the controller 62 includes a processor 64 and a memory 66. The processor 64 may represent multiple processors, and the memory 66 may represent multiple memories.

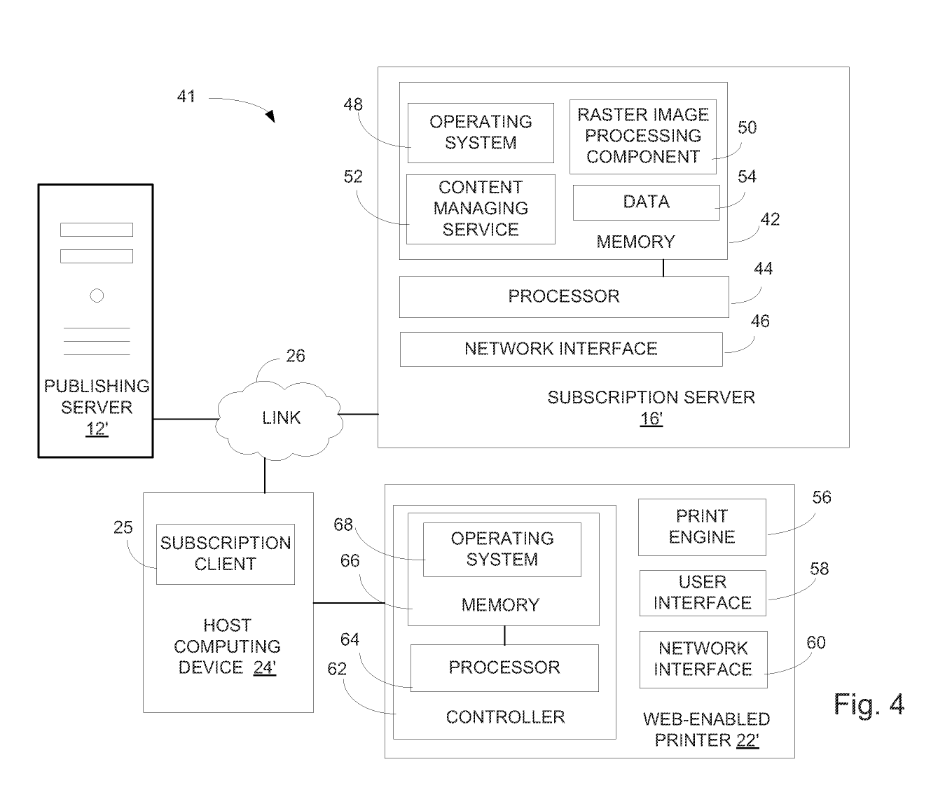

Content manager 28 may also be implemented in an environment such as environment 41 of FIG. 4. Environment 41 is substantially the same as environment 40 of FIG. 3, except that printer 22′ is web-enabled by virtue of being connected to a web-enabled host computing device 24′ rather directly connecting to the link 26. Host computing device 24′ represents generally any web-enabled computing device that is connected to printer 22′, e.g. via a cable or a wireless connection. In an embodiment, host computing device 24′ may include a subscription client 25 that includes a combination of hardware and programming configured for communication with subscription server 16′. The descriptions of the publishing server 12′, the subscription server 16′ and printer 22′ components of FIG. 3 provided in paragraphs [00024] to [00032] of this application apply to the publishing server 12′, the subscription server 16′ and web-enabled printer 22′ of FIG. 4, with the exceptions noted above in this paragraph [00033].

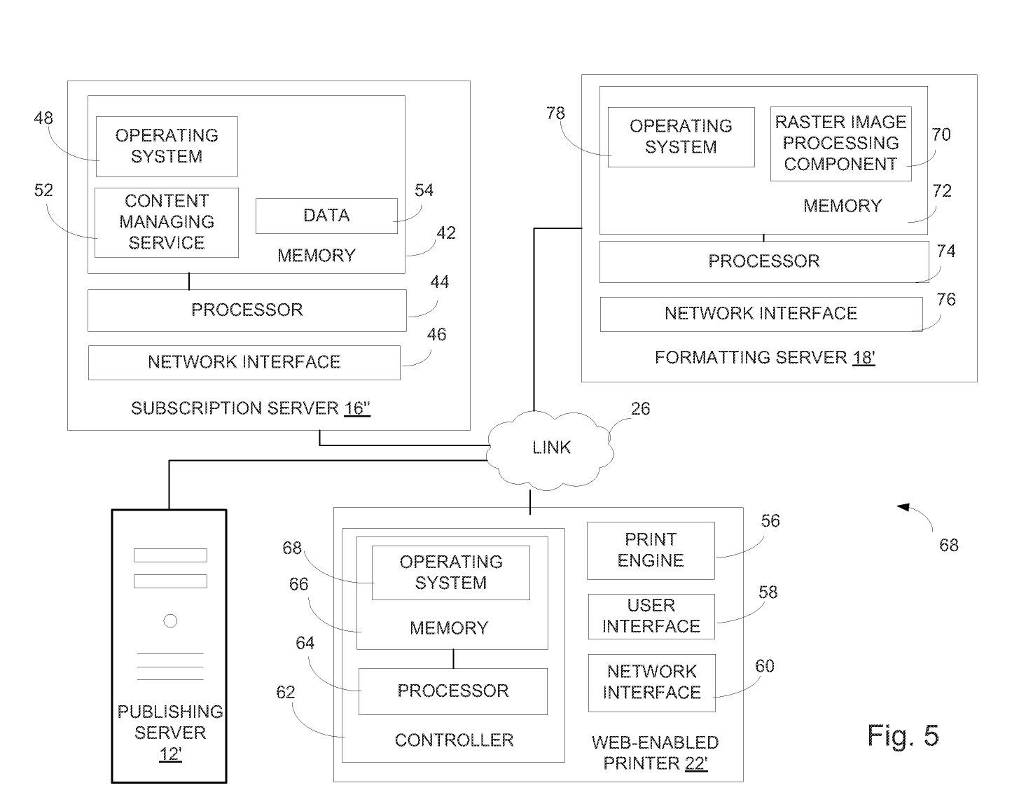

Content manager 28 may also be implemented in an environment such as environment 68 of FIG. 5. Environment 68 includes publishing server 12′, subscription server 16″, formatting server 18′, and web-enabled printer 22′ interconnected via link 26. Environment 68 is substantially similar to environment 40 described in FIG. 3 except that subscription server 16″ does not include a raster image processing component and formatting of subscribed-for content does not occur at the subscription server, and a formatting server 18 is included in environment 68. In the environment 68 of FIG. 5, formatting server 18′ includes a raster image processing component 70 for performing formatting operations. Publishing server 12′ represents generally any computing device capable of providing source content to and communicating with subscription server 16′, and receiving information relating to the source content from subscription server 16′.

Subscription server 16″ represents generally any computing device capable of obtaining content from, and communicating with, publishing server 12′. Subscription server 16′ is additionally capable of receiving requests for subscribed-for content from, causing subscribed-for content to be obtained by, and communicating with, a web-enabled printer 22′. Subscription server 16″ is shown to include a memory 42, a processor 44, and a network interface 46. Unlike the subscription server 16′ shown in FIG. 3, subscriptions server 16″ does not include a raster image processing component. In this example, as the formatting of the subscribed-for content occurred at formatting server 18′, the content is obtained by the printer 22′ after the formatting. The detailed description of the subscription server 16′ of FIG. 3 provided in paragraphs [00025] to [00029] of this application also applies to the subscription server 16″ of FIG. 5, with the exceptions noted in paragraph [00034] and this paragraph [00035]. When applying the FIG. 3 description of a subscription server to FIG. 5, incidences of the subscription server 16′ shall be read as subscription server 16″.

Web-enabled printer 22′ represents generally a computing device capable of obtaining subscribed-for content from subscription server 16″, producing printed output from the subscribed-for content, and communicating information relating to the obtained subscribed-for content and/or the printed output back to the subscription server 16′. The detailed description of the web enabled printer 22′ of FIG. 3 provided in paragraphs [00030] to [00032] of this application also applies to the web-enabled printer 22′ of FIG. 5.

Formatting server 18′ represents generally any computing device capable of obtaining subscribed-for content from subscription server 16″, communicating with subscription server 16″, and formatting the subscribed-for content in accordance with the protocol established at subscription server 16′. Formatting server 18′ is shown to include a memory 72, a processor 74, and a network interface 76. In a given implementation, processor 74 may represent multiple processors, and the memory 72 may represent multiple memories. An executable program may be stored in any portion or component of memory 72. Memory 72 is shown to include an operating system 78 and a raster image processing component 70. Operating system 78 represents generally any software platform on top of which other programs or applications such as the raster image processing component 70 run. Examples include Linux® and Microsoft Windows®. Raster image processing component 70 represents generally any combination of hardware and software capable of converting digital information about fonts and graphics that describes the intended appearance of the content, and translating that information into an image composed of individual dots that a printer can output. Network Interface 76 represents generally any combination of hardware and programming configured for electronically connecting formatting server 18′ to link 26. In an embodiment, the network interface may comprise a network interface card, a network adapter, a network interface controller, and or a LAN adapter.

In the example of FIG. 5, the formatting of the subscribed-for content occurs utilizing raster image processing component 70 at formatting server 18′. After the content has been formatted at formatting server 18′, the content managing service 52 at subscription server 16″ causes the subscribed-for content to be obtained by the web-enabled printer 22′. In an embodiment, formatting server 18′ is part of the same computing system that includes the subscription server 16″. In another embodiment, formatting server 18′ is part of a computer system that is separate from the computer system that includes subscription server 16″.

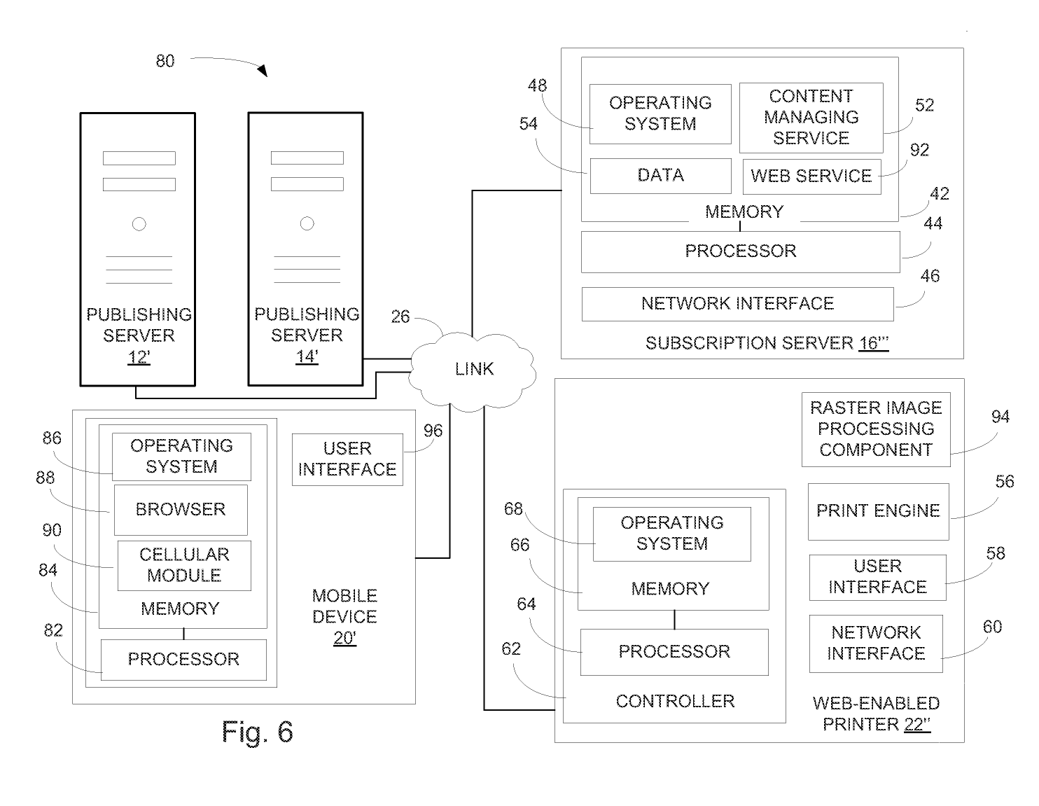

Content manager 28 may also be implemented in an environment such as environment 80 of FIG. 6. Environment 80 includes publishing servers 12′ and 14′, mobile device 20′, subscription server 16′″, and web-enabled printer 22″ interconnected via link 26. Environment 68 is substantially similar to environment 68 described in FIG. 5 except as described in the remainder of this paragraph. Subscription server 16″ obtains source content from two publishing servers 12′ and 14′ rather than one publishing server as in environment 40 (FIG. 3). In the environment 80 of FIG. 6, subscription server 16′″ receives a request from a mobile device 20′, the request for scheduled automatic delivery, without user intervention, of subscribed-for content to printer 22″. In the environment 68 of FIG. 5, the request is received from the web-enabled printer. Environment 80 of FIG. 6 does not include a formatting server. In the environment 80 of FIG. 6, printer 22″ includes a raster image processing component 32 for performing formatting operations at printer 22″ rather than at a formatting server.

Publishing servers 12′ and 14′ represent generally any computing device capable of providing source content to and communicating with subscription server 16′, and receiving information relating to the source content from subscription server 16′. In an example, publishing server 12′ may send or make available first source content to subscription server 16′″ on an hourly basis, and publishing server 14 may send or make available second source content to subscription server 16′″ on a daily basis. In an embodiment, the first and second publishing servers are servers in distinct computing systems. In an example, publishing server 12′ may be comprised within a first computing system that is a news publishing system that updates content hourly, and publishing server 14′ may be comprised within a second computing system that is a publishing system that publishes daily crossword puzzles and other games.

Mobile device 20′ represents generally any computing device capable of sending to another computing device, such as subscription server 16′″, a request for scheduled automatic delivery of subscribed-for content to a web enabled printer 22″. The subscribed-for content comprises at least a portion of the first source content that is sent by publishing server 12′ to subscription server 16′″, and at least a portion of the second source content that is sent by publishing server 14′ to subscription server 16′″. In a given implementation, the mobile device 20′ includes a processor 82 and a memory 84. The processor 82 may represent multiple processors, and the memory 84 may represent multiple memories. Memory 84 is shown to include an operating system 86, a web browser 88 and a cellular module 90. Operating system 86 represents generally any software platform on top of which other programs or applications such as the web browser 88 and the cellular module 90 run. Examples include Palm® OS, iPhone® OS, Blackberry® OS, Windows®, Phone 7 and Symbian™ OS. Web browser 88 represents generally any combination of hardware and programming configured to send network requests for content to other computing devices. In this example, web browser 88 is configured to send a request to web service 92 at subscription server 16′″ a request for scheduled automatic delivery of content to a web enabled printer 22′. Web browser 88 may also be configured to send requests for content to web sites that do not include subscription server 16′″, and may be configured to format such content for display of a device view and/or other presentation of the content at the mobile device 20′ at a touchscreen or other display device comprised within mobile device 20′. In this example, cellular module 90 represents generally any combination of hardware and software configured to enable radio communication between mobile device 20′ and other computing devices over a cellular communication network.

User interface 96 represents generally any combination of hardware and programming that enables a user to enter commands at mobile device 20′. User interface 96 may be implemented through one or more physical buttons or a touchscreen interface. In an example, user interface 96 is a touchscreen device and includes a combination of hardware and programming capable of presenting a visual display of content for viewing by a user and of receiving a request or other instructions from a user via the user's interaction, e.g. via a touch, with the touchscreen. In an embodiment, the user interface is a touch screen interface configured to display logos, which logos when selected initiate sending of a request for subscribed-for content to subscription server 16′″. In an embodiment, the request for subscribed-for content is initiated by a user's interacting with a single icon displayed by the touchscreen user interface. In an embodiment, the request is initiated by a user's single interaction, e.g. a single touch, with a single icon displayed by a touchscreen user interface.

Subscription server 16′″ represents generally any computing device capable of obtaining content from, and communicating with, publishing servers 12′ and 14′. Subscription server 16′″ is additionally capable of receiving requests for subscribed-for content from, and communicating with, mobile device 20′, and causing subscribed-for content to be obtained by, and communicating with, a web-enabled printer 22″. Subscription server 16′″ is shown to include a memory 42, a processor 44, and a network interface 46. In a given implementation, processor 46 may represent multiple processors, and the memory 42 may represent multiple memories. In an embodiment, the subscription server 16′″ may include a number of software components that are stored in a computer-readable medium, such as memory 42, and are executable by processor 44. An executable program may be stored in any portion or component of memory 42. Memory 42 is shown to include an operating system 48, a content managing service 52, a web service 92 and data 54. Operating system 48 represents generally any software platform on top of which other programs or applications such as the raster image processing component 50, the content managing service 52, and the web service 92 run. Web service 92 represents generally any combination of hardware and programming capable of receiving a request for subscribed-for content that is sent via a browser, e.g. browser 88 of mobile computing device 20′. The description of the data 54 and the network interface 46 of FIG. 3 provided in paragraphs [00028] to [00029] of this application also apply to the data 54 and network interface 46 depicted in subscription server 16′″ of FIG. 6.

Content managing service 52 represents generally any programming, that, when executed, implements the functionality of the content manager 28 of FIG. 2. In particular, content managing service 52, when executed by processor 44, is responsible for obtaining source content from a computing system. In this example, the content may be obtained from publishing servers 12′ and 14′ and stored in memory 42. Content managing service 52 is additionally responsible for receiving a request for scheduled automatic delivery, without user intervention, of subscribed-for content to a web-enabled printer such as printer 22″. The subscribed-for content comprises at least a portion of first source content that is obtained from publishing server 12′ and second source content that is obtained from publishing server 14′. In this example, the received request is a request that is initiated via a user's interaction with a user interface 96 at mobile device 20′. Content managing service 52 is additionally responsible for establishing a protocol for printing of the subscribed-for content at web-enabled printer 22″. In this example, the protocol is established at least in part utilizing information discerned from the request for scheduled automatic delivery, and utilizing data 54 stored in a memory 42 within the subscription server 16′″. Content managing service 52 is additionally responsible for causing formatting of the subscribed-for content, in accordance with the protocol. In this example, the formatting of the subscribed-for content occurs utilizing a raster image processing component 50 at printer 22″. Content managing service 52 is additionally responsible for causing the subscribed-for content to be obtained by the web-enabled printer. In this example, as the formatting of the subscribed-for content occurred at printer 22″, the content is obtained by the printer 22′″ before the formatting.

Web-enabled printer 22″ represents generally a computing device capable of obtaining subscribed-for content from subscription server 16′″, formatting the subscribed-for content, producing printed output from the subscribed-for content, and communicating information relating to the obtained subscribed-for content and/or the printed output back to the subscription server 16′″. Except as described in this paragraph below, the detailed description of the printer 22′ of FIG. 3 provided in paragraphs [00030] to [00032] of this application may also be applied to the web-enabled printer 22″ of FIG. 6. When applying the FIG. 3 description of a printer to FIG. 6, incidences of the text printer 22′ shall be read as printer 22″. Web-enabled printer 22″ is additionally shown to include a raster image processing component 94. Raster image processing component 94 represents generally any combination of hardware and software capable of formatting subscribed-for content that is obtained from subscription server 16′″. The raster image processing component 94 is configured to convert digital information about fonts and graphics that describes the intended appearance of the content, and translate that information into an image composed of individual dots that a printer can output. Controller 62 is capable coordinating the operation of raster image processing component 94 along with the operation of print engine 56, user interface 58, and network interface 60.

In the foregoing discussion, various components were described as combinations of hardware and programming. Such components may be implemented in a number of fashions. In one example, the programming may be processor executable instructions stored on tangible memory media and the hardware may include a processor for executing those instructions. Thus, certain elements operating on the same device may share a common processor and common memory media.

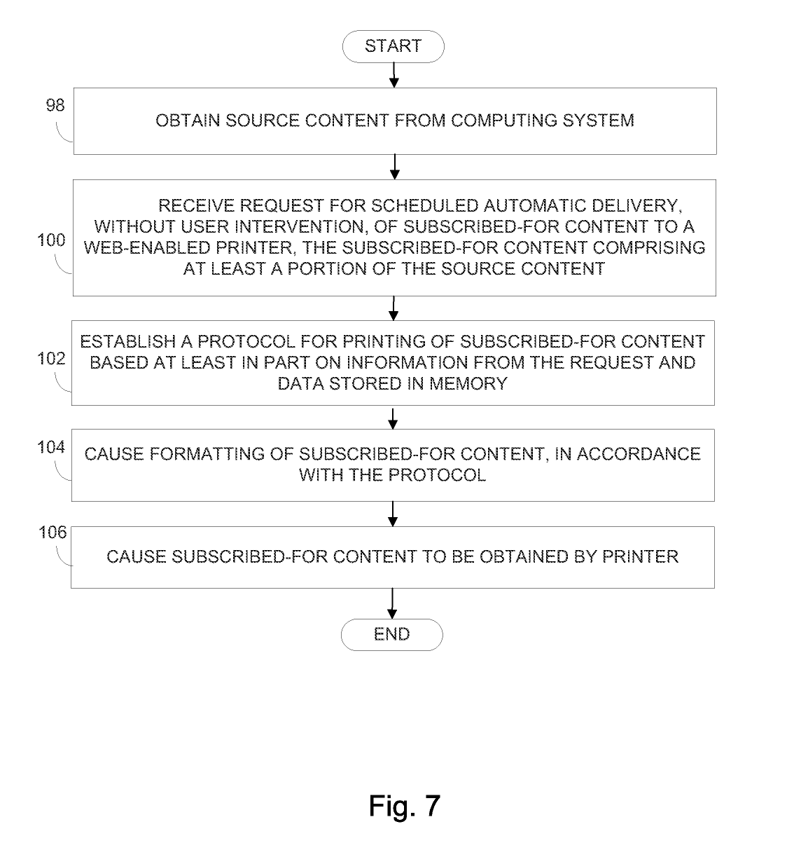

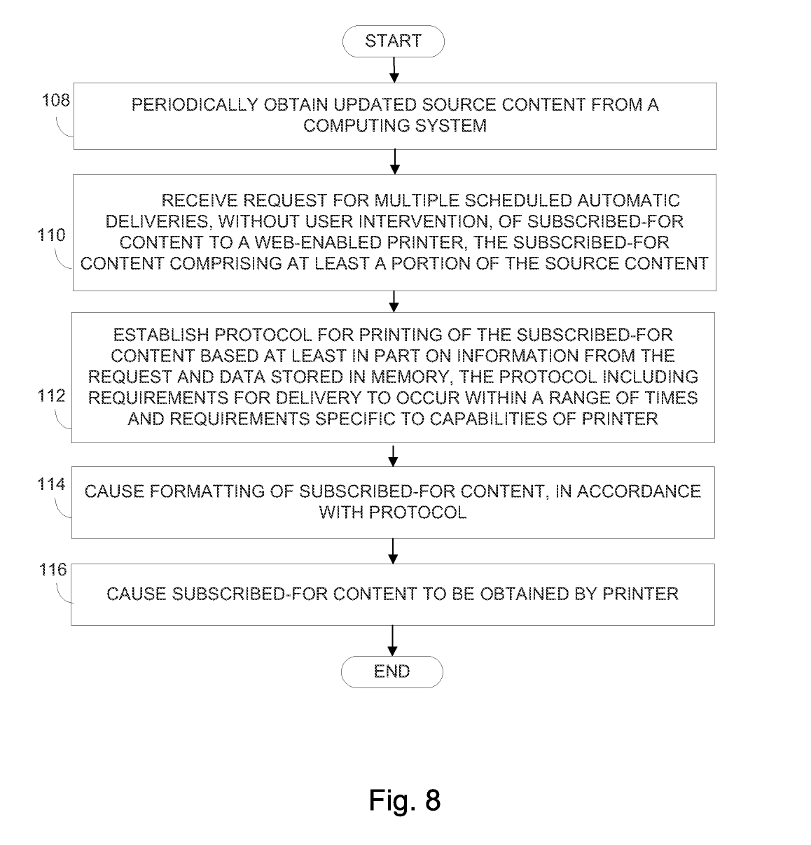

OPERATION: FIGS. 7 and 8 are flow diagrams depicting example embodiments of a method for scheduled delivery of content. In discussing FIGS. 7 and 8, reference may be made to the diagrams of FIGS. 1-6 to provide contextual examples. Implementation, however, is not limited to those examples.

Starting with FIG. 7, source content is obtained from a computing system (block 98). Referring back to FIG. 2, the source content module 30 may be responsible for implementing block 98.

Continuing with the flow diagram of FIG. 7, a request is received, the request for scheduled automatic delivery, without user intervention, of subscribed-for content to a web-enabled printer. The subscribed-for content comprises at least a portion of the source content (block 100). Referring back to FIG. 2, the subscription module 32 may be responsible for implementing block 100.

Continuing with the flow diagram of FIG. 7, a protocol for printing of the subscribed-for content is established based at least in part on information from the request and data stored in a memory, (block 102). Referring back to FIG. 2, the protocol module 34 may be responsible for implementing block 102.

Continuing with the flow diagram of FIG. 7, formatting of the subscribed-for content is caused, in accordance with the protocol (block 104). Referring back to FIG. 2, the formatting module 36 may be responsible for implementing block 104.

Continuing with the flow diagram of FIG. 7, the subscribed-for content is caused to be obtained by the printer (block 106). Referring back to FIG. 2, the content delivery module 38 may be responsible for implementing block 106.

Moving on to FIG. 8, in a particular implementation, updated source content is periodically obtained from a computing system (block 108). In embodiments, updated source content may be received or retrieved from a publishing computing system at regular, e.g. daily, weekly, or monthly, intervals. Referring back to FIG. 2, the source content module 30 may be responsible for implementing block 108.

Continuing with the flow diagram of FIG. 8, a request is received. The request is a request for multiple scheduled automatic deliveries, without user intervention, of subscribed-for content to a web-enabled printer. The subscribed for content comprises at least a portion of the source content (block 110). In an embodiment, the request may be received from a user via a user interface of the web-enabled printer. In another embodiment, the request may be received from a user via a user interface of a computing device other than the web-enabled printer, e.g. a mobile computing device with internet connectivity. Referring back to FIG. 2, the subscription module 32 may be responsible for implementing block 110.

Continuing with the flow diagram of FIG. 8, a protocol is established based at least in part on information from the request and data stored in a memory. The protocol is a protocol for printing of the subscribed-for content that includes requirements for delivery to occur within a range of times and requirements specific to capabilities of the printer (block 112). In an embodiment, the discerned information may indicate that the web-enabled printer has certain unattended duplexing capabilities, and the protocol includes requirements commensurate with the duplexing capabilities of that printer. In an embodiment, the information will include geography in which the printer is situated, and the data that is stored in memory includes time zone information relevant to the printer. The protocol may include requirements for printing of the subscribed-for content within a scheduled range of times, for example, between 6 a.m. and 7:30 a.m. of the applicable time zone. The protocol may include other requirements relating to discerned information regarding the printer, the user, and/or the content. Referring back to FIG. 2, the protocol module 34 may be responsible for implementing block 112.

Continuing with the flow diagram of FIG. 8, formatting of the subscribed-for content is caused, in accordance with the protocol (block 114). Referring back to FIG. 2, the formatting module 36 may be responsible for implementing block 114. In embodiments, the formatting may occur utilizing a raster image processor located at a first computing device that receives the request, at the web-enabled printer, or at a computing device other than the first computing device and the web-enabled printer.

Continuing with the flow diagram of FIG. 8, the subscribed-for content is caused to be obtained by the printer (block 116). Referring back to FIG. 2, the content delivery module 38 may be responsible for implementing block 116. In an embodiment the printer may be configured to print the subscribed-for content immediately upon receipt at the printer. In another embodiment, the printer may be configured to delay printing the subscribed-for content until a prescribed time or until a user initiates printing.

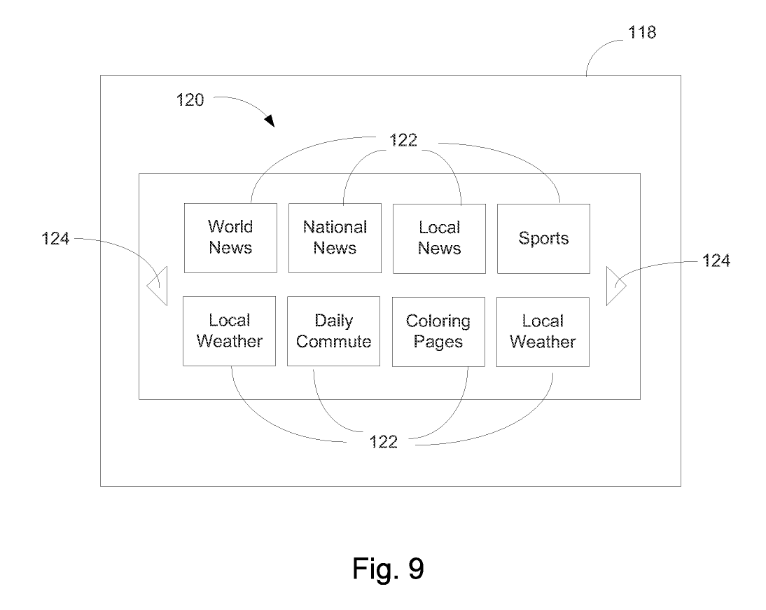

EXAMPLE: FIG. 9 depicts an example user interface 118 from which a user may initiate a request for scheduled automatic delivery of content to a web-enabled printer, according to an embodiment. In an embodiment, the example user interface 118 is a combination of hardware and programming included within a web-enabled printer, as in the example of user interface 58 included in printer 22′ of FIG. 5. In another embodiment, the example user interface 118 is a combination of hardware and programming included within a computing device other than a web-enabled printer, as in the example of user interface 96 included in mobile device 20′ of FIG. 6.

FIG. 9 depicts an example screen shot of a display 120 that may be presented to a user via user interface 118. In this example, the display 120 presents a user with eight icons 122 that the user may choose to interact with to initiate a request for scheduled automatic delivery of subscribed-for content to a web-enabled printer. The icons 122 include choices of “Word News”, “National News”, “Local News”, “Sports”, “Local Weather”, “Daily Commute”, “Coloring Pages” and “Local Weather” as content that the user may chose from. In an embodiment the user interface 118 is a touchscreen display, and the user may interact with an icon 122 by touching a portion of the touchscreen that displays the icon 122. In an embodiment, a user may prompt the user interface 118 to display additional content choices by virtue of the user interacting with “more content” icons or symbols 124 that may be part of the display 120.

In an embodiment, the request for automatic scheduled delivery of subscribed-for content to a printer is initiated via a user's interaction with a single icon 122 on the user interface 118. In an example, a subscription server such as subscription server 16′ of FIG. 3 may be configured to receive a request from a computing device that incorporates user interface 118, the request indicating that a user has selected the “Local News” for scheduled delivery to user's web-enabled printer 22′ (FIG. 3). A protocol is established for printing of the subscribed-for “Local News” content based at least in part on information from the request and on data stored in a memory of subscription server 16′ (FIG. 3). Information that may be discerned from the request may include printer model information, and/or printer location information. The data that is utilized in establishing the protocol may include capabilities of the printer model, default settings for the printer model, and/or time zone information relevant to the location of the printer.

In other embodiments, a user may interact with the user interface 118 in a manner other than touching a touchscreen, for example by interacting with buttons, or by giving audible instructions that are received and interpreted at the user interface 118.

CONCLUSION: The diagram of FIG. 1 is used to depict an example environment in which various embodiments may be implemented. Implementation, however, is not so limited. FIGS. 2-6 show the architecture, functionality, and operation of various embodiments. Various components illustrated in FIGS. 2-6 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present disclosure may be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 7-8 show specific orders of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A computer readable medium storing computer executable instructions that when executed implement a method for scheduled delivery of content, comprising:
obtaining first source content from a first computing system;
receiving a request for scheduled automatic delivery, without user intervention, of subscribed-for content to a web-enabled printer, the subscribed-for content comprising at least a portion of the first source content;
establishing a protocol for printing of the subscribed-for content based at least in part on information from the request and data stored in a memory;
causing formatting of the subscribed-for content, in accordance with the protocol; and
causing the subscribed-for content to be obtained by the printer.

2. The method of claim 1, wherein the request comprises a request for multiple scheduled automatic deliveries, and wherein updated first source content is periodically obtained from the first computing system.

3. The method of claim 1, wherein the received request is initiated via a user interface at the printer.

4. The method of claim 1, wherein the received request is initiated via a user interface at a web-enabled computing device other than the printer.

5. The method of claim 3, wherein the request is initiated by user interaction with a single icon on the user-interface.

6. The method of claim 4, wherein the request is initiated by user interaction with a single icon on the user-interface.

7. The method of claim 1, wherein the protocol comprises scheduling the delivery to occur with a range of times.

8. The method of claim 1, wherein the protocol includes requirements specific to the capabilities of the web-enabled printer.

9. The method of claim 1, wherein the information comprises a model of the printer and the data comprises capabilities of the model.

10. The method of claim 1, wherein the information comprises a location of the printer and the data comprises time zone information for the location.

11. The method of claim 1, wherein formatting occurs at a second computing device distinct from a first computing device, the first computing device receiving the request and receiving the first source content.

12. The method of claim 1, wherein the formatting occurs at a computing device that is connected to the printer via a cable or wireless connection.

13. The method of claim 1, wherein the formatting occurs at the printer.

14. The medium of claim 1, wherein the web-enabled printer comprises a printer that is web-enabled by virtue of being connected to a web-enabled host computing device.

15. A system for scheduled delivery of content, comprising:
a source content module, configured to obtain first source content from a first computing system;
a subscription module, configured to receive a request for scheduled automatic delivery, without user intervention, of subscribed-for content to a web-enabled printer, the subscribed-for content comprising at least a portion of the first source content;
a protocol module, configured to establish a protocol for printing of the subscribed-for content based at least in part on information from the request and data stored in a memory;
a formatting module, configured to cause formatting of the subscribed-for content, in accordance with the protocol; and
a content delivery module, configured to cause the subscribed-for content to be obtained by the printer.

16. The system of claim 15, wherein the request comprises a request for multiple scheduled automatic deliveries, and wherein updated first source content is periodically obtained from the first computing system.

17. The system of claim 15, further comprising obtaining second source content from a second computing system, and wherein the subscribed-for content comprises at least a portion of the second source content.

18. The system of claim 15, wherein the received request is initiated via a user interface at the printer.

19. The system of claim 15, wherein the received request is initiated via a user interface at a web-enabled computing device other than the printer.

20. A method for scheduled delivery of content, comprising:
periodically obtaining first source content from a first computing system and second source content from a second computing system;
receiving a request for multiple scheduled automatic deliveries, without user intervention, of subscribed-for content to a web-enabled printer, the subscribed-for content comprising at least a portion of the first source content and at least a portion of the second source content;
establishing a protocol for printing of the subscribed-for content based at least in part on information from the request and data stored in a memory,
wherein the information comprises a location of the printer and the data comprises time zone information for the location;
wherein the protocol comprises
scheduling the delivery to occur with a range of times, and
requirements specific to the capabilities of the web-enabled printer;
causing formatting of the subscribed-for content in accordance with the protocol, the formatting occurring at a second computing device distinct from a first computing device, the first computing device receiving the request and obtaining the first source content; and
causing the subscribed-for content to be obtained by the printer.
